(19) United States
(12) Patent Application Publication
(10) Pub. No.: US 2015/0185534 A1
(43) Pub. Date: Jul. 2, 2015

(54) LIQUID CRYSTAL DISPLAY

(71) Applicant: SAMSUNG DISPLAY CO., LTD, Yongin-City (KR)

(72) Inventors: Hyung Jun Park, Seongnam-si (KR); Seong Young Lee, Hwaseong-si (KR); Jae Won Kim, Asan-si (KR)

(21) Appl. No.: 14/586,040

(22) Filed: Dec. 30, 2014

(30) Foreign Application Priority Data
Dec. 31, 2013 (KR) 10-2013-0169357

(51) Int. Cl. G02F 1/1362; G02F 1/1343; G02F 1/1368

(52) U.S. Cl. CPC G02F 1/13624; G02F 1/1368; G02F 1/136286; G02F 1/134309; G02F 2001/134345

(57) ABSTRACT

A liquid crystal display includes first and second subpixel electrodes, a common electrode and first and second reference voltage lines. The first and second subpixel electrodes are electrically connected through first and second switching elements to a data line supplied with a data voltage. The first subpixel electrode is electrically connected through a third switching element to one of the first and second reference voltage lines. A polarity of the first reference voltage is different from a polarity of the second reference voltage with respect to the common voltage supplied to the common electrode. Liquid crystal molecules are disposed between the first subpixel electrode and the common electrode and between the second subpixel electrode and the common electrode.

### CROSS-REFERENCE TO RELATED APPLICATION

This application claims priority under 35 U.S.C. §119 to Korean Patent Application No, 10-2013-0169357 filed on Dec. 31, 2013 in the Korean Intellectual Property Office, the disclosure of which is incorporated by reference herein in its entirety.

### TECHNICAL FIELD

The present invention relates to a liquid crystal display.

### DISCUSSION OF RELATED ART

Liquid crystal displays (LCDs) are widely used flat panel displays. LCDs include a pair of panels provided with field-generating electrodes, such as pixel electrodes and a common electrode, and a liquid crystal (LC) layer interposed between the two panels. The LCDs display images by applying voltages to the field-generating electrodes to generate an electric field in the LC layer. The orientations of LC molecules therein determine polarization of light incident thereto, and side visibility of the LCDs.

### SUMMARY

According to an exemplary liquid crystal display of the present invention, First and second reference voltage lines are supplied with first and second reference voltages. A first pixel includes a first switching element, a second switching element, a third switching element, a first subpixel electrode, a second subpixel electrode and a common electrode. The first switching element electrically connects a first data line to the first subpixel electrode. The second switching element electrically connects the first data line to the second subpixel electrode. The third switching element electrically connects the first reference voltage line to the first subpixel electrode. A second pixel includes a fourth switching element, a fifth switching element, a sixth switching element, a third subpixel electrode, a fourth subpixel electrode and the common electrode. The fourth switching element electrically connects a second data line to the third subpixel electrode. The fifth switching element electrically connects the second data line to the fourth subpixel electrode. The sixth switching element electrically connects the second reference voltage line to the third subpixel electrode. A polarity of the first reference voltage is different from a polarity of the second reference voltage with respect to a common voltage supplied to the common electrode. Liquid crystal molecules are disposed between the first subpixel electrode and the common electrode and between the second subpixel electrode and the common electrode.

According to an exemplary liquid crystal display of the present invention, a first reference voltage line and a second reference voltage line are supplied with a first reference voltage and a second reference voltage having different polarities from each other. A pixel electrode includes a first subpixel electrode and a second subpixel electrode. A common electrode is supplied with a common voltage. A first switching element is connected to a gate line, a data line, and the first subpixel electrode. A second switching element is connected to the gate line, the data line, and the second subpixel electrode. A third switching element is connected to the gate line, the first subpixel electrode, and one of the first reference voltage line and the second reference voltage line. The pixel electrode overlaps the first reference voltage line and the second reference voltage line. A voltage difference between the first subpixel electrode and a common electrode is greater than a voltage difference between the second subpixel electrode and the common electrode.

### BRIEF DESCRIPTION OF THE DRAWINGS

These and other features of the present invention will become more apparent by describing in detail exemplary embodiments thereof with reference to the accompanying drawings of which:

FIG. 1 is an equivalent circuit diagram of adjacent pixels of a liquid crystal display according to an exemplary embodiment of the present invention;

FIG. 2 is a layout view of a liquid crystal display according to an exemplary embodiment of the present invention;

FIG. 3 is a cross-sectional view of the liquid crystal display of FIG. 2 taken along the line III-III;

FIG. 4 is a layout view of a portion of the liquid crystal display of FIG. 2;

FIG. 5 is a waveform diagram for describing a voltage change of a pixel area depending on a voltage which is applied for each frame;

FIG. 6 and FIG. 7 are graphs illustrating a transmittance change depending on pixel voltages of a liquid crystal display according to an exemplary embodiment of the present invention; and

FIG. 8 is a layout view of the liquid crystal display according to an exemplary embodiment of the present invention.

### DETAILED DESCRIPTION OF EXEMPLARY EMBODIMENTS

Exemplary embodiments of the present invention will be described below in detail with reference to the accompanying drawings. However, the present invention may be embodied in different forms and should not be construed as limited to the embodiments set forth herein. In the drawings, the thickness of layers and regions may be exaggerated for clarity. It will also be understood that when an element is referred to as being “on” another element or substrate, it may be directly on the other element or substrate, or intervening layers may also be present. It will also be understood that when an element is referred to as being “coupled to” or “connected to” another element, it may be directly coupled to or connected to the other element, or intervening elements may also be present. Like reference numerals may refer to the like elements throughout the specification and drawings.

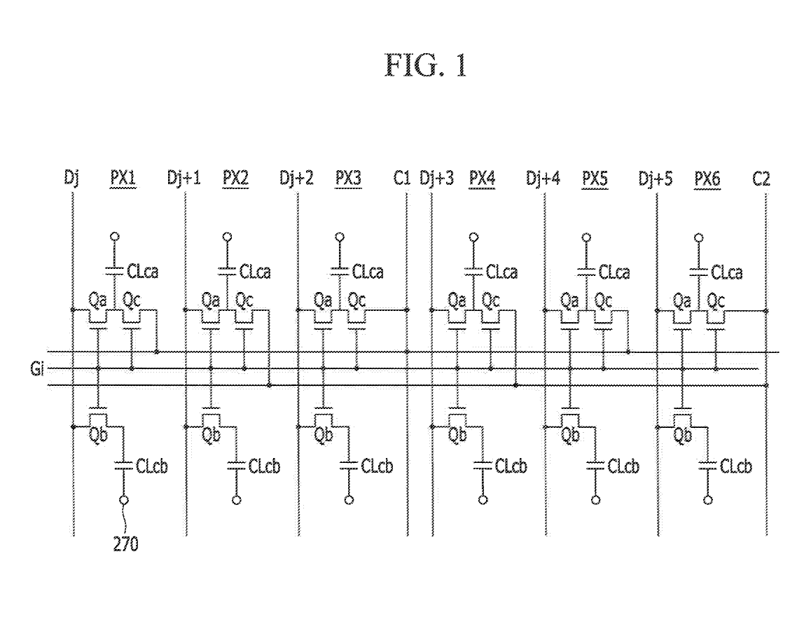

Now, layouts of signal lines and pixels of a liquid crystal display according to an exemplary embodiment of the present invention and a driving method thereof will be described with reference to FIG. 1. FIG. 1 is an equivalent circuit diagram of adjacent pixels of a liquid crystal display according to an exemplary embodiment of the present invention.

Referring to FIG. 1, a liquid crystal display according to the present exemplary embodiment includes a first pixel PX1, a second pixel PX2, a third pixel PX3, a fourth pixel PX4, a fifth pixel PX5, and a sixth pixel PX6 adjacent to each other in a pixel row direction.

Signal lines Gi, Dj, D(j+1), D(j+2), D(j+3), D(j+4), D(j+5), C1, and C2 include a gate line Gi transmitting gate signals (referred to as “scanning signals”), data lines Dj, D(j+1), D(j+2), D(j+3), D(j+4), and D(j+5) transmitting data voltages, and a first reference voltage line C1 and a second reference voltage line C2 transmitting predetermined reference voltages.

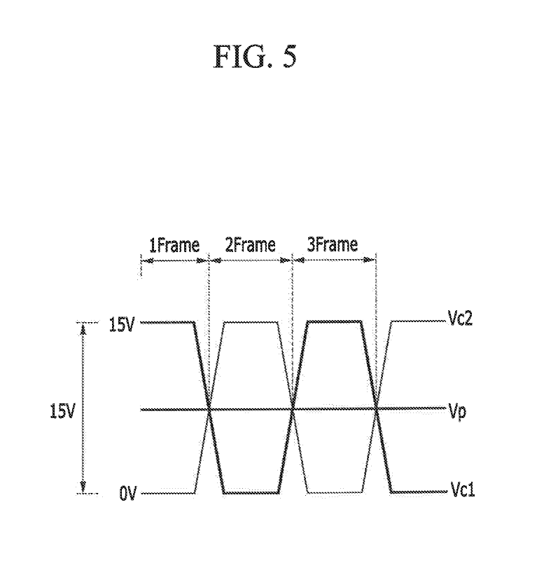

A first reference voltage and a second reference voltage which have a predetermined magnitude are applied to the first reference voltage line C1 and the second reference voltage line C2. Polarities of the first reference voltage and the second reference voltage are changed for each frame. For example, in the case where the magnitude of a common voltage is about 7.5 V, the first reference voltage may have a value of about 15 V or about 0 V for each frame, and the second reference voltage may have a value of about 0 V or about 15 V. The voltage relationship between the first and second reference voltages will be later described in detail with reference to FIG. 5. The first reference voltage and the second reference voltage may be larger or smaller than a maximum value of the data voltage transmitted by the data lines Dj to D(J+5). Further, first voltage differences are created between the first and second reference voltages and the common voltage if the reference voltages have positive polarities with respect to the common voltage. Second voltage differences are created between the first and second reference voltages and the common voltage if the first reference voltage and the second reference voltage have negative polarities with respect to the common voltage. The first voltage differences may be different from the second voltage differences.

A first voltage transmitting part T1 is connected to the first reference voltage line C1, and a second voltage transmitting part T2 is connected to the second reference voltage line C2.

The first pixel PX1 includes the gate line Gi, the first data line Dj, the first voltage transmitting part T1 connected to the first reference voltage line C1, and a first switching element Qa, a second switching element Qb, a third switching element Qc, a first liquid crystal capacitor Clca, and a second liquid crystal capacitor Clcb.

The first switching element Qa and the second switching element Qb are connected to the gate line Gi and the first data line Dj. The third switching element Qc is connected to the gate line Gi, the first voltage transmitting part T1 connected to the first reference voltage line C1, and an output terminal of the first switching element Qa.

The first switching element Qa and the second switching element Qb are three-terminal elements such as a thin film transistor of which a control terminal is connected to the gate line Gi and an input terminal is connected to the first data line Dj. Further, the output terminal of the first switching element Qa is connected to the first liquid crystal capacitor Clca and an output terminal of the third switching element Qc, and the output terminal of the second switching element Qb is connected to the second liquid crystal capacitor Clcb.

The third switching element Qc is a three-terminal element such as a thin film transistor, and includes a control terminal connected to the gate line Gi, the input terminal connected to the first voltage transmitting part T1 connected to the first reference voltage line C1, and an output terminal connected to the first liquid crystal capacitor Clca.

The second pixel PX2 includes the gate line Gi, the second data line D(j+1), the second voltage transmitting part T2 connected to the second reference voltage line C2, and the first switching element Qa, the second switching element Qb, the third switching element Qc, the first liquid crystal capacitor Clca, and the second liquid crystal capacitor Clcb.

The first switching element Qa and the second switching element Qb are connected to the gate line Gi and the second data line D(j+1). The third switching element Qc is connected to the gate line Gi, the second voltage transmitting part T2 connected to the second reference voltage line C2, and the output terminal connected to the first switching element Qa.

The first switching element Qa and the second switching element Qb are three-terminal elements such as a thin film transistor of which a control terminal connected to the gate line Gi and an input terminal is connected to the second data line D(j+1). Further, the output terminal of the first switching element Qa is connected to the first liquid crystal capacitor Clca and the output terminal of the third switching element Qc, and the output terminal of the second switching element Qb is connected to the second liquid crystal capacitor Clcb.

The third switching element Qc is a three-terminal element such as a thin film transistor, and includes a control terminal connected to the gate line Gi, an input terminal connected to the second voltage transmitting part T2 connected to the second reference voltage line C2, and an output terminal connected to the first liquid crystal capacitor Clca.

The third pixel PX3 includes the gate line Gi, the third data line D(j+2), the first reference voltage line C1, and the first switching element Qa, the second switching element Qb, the third switching element Qc, the first liquid crystal capacitor Clca, and the second liquid crystal capacitor Clcb.

The first switching element Qa and the second switching element Qb are connected to the gate line Gi and the third data line D(j+2). The third switching element Qc is connected to the gate line Gi, the first reference voltage line C1, and the output terminal connected to the first switching element Qa.

The first switching element Qa and the second switching element Qb are three-terminal elements such as a thin film transistor of which a control terminal is connected to the gate line Gi and an input terminal is connected to the third data line D(j+2). Also, the output terminal of the first switching element Qa is connected to the first liquid crystal capacitor Clca and the output terminal connected to the third switching element Qc, and the output terminal of the second switching element Qb is connected to the second liquid crystal capacitor Clcb.

The third switching element Qc is also a three-terminal element such as a thin film transistor, and includes a control terminal connected to the gate line Gi, an input terminal connected to the first reference voltage line C1, and an output terminal connected to the first liquid crystal capacitor Clca.

The fourth pixel PX4 includes the gate line Gi, the fourth data line D(j+3), the second voltage transmitting part T2 connected to the second reference voltage line C2, and the first switching element Qa, the second switching element Qb, the third switching element Qc, the first liquid crystal capacitor Clca, and the second liquid crystal capacitor Clcb.

The first switching element Qa and the second switching element Qb are connected to the gate line Gi and the fourth data line D(j+3). The third switching element Qc is connected to the gate line Gi, the second voltage transmitting part T2 connected to the second reference voltage line C2, and the output terminal of the first switching element Qa.

The first switching element Qa and the second switching element Qb are three-terminal elements such as a thin film transistor of which a control terminal is connected to the gate line Gi and an input terminal is connected to the fourth data line D(j+3). The output terminal of the first switching element Qa is connected to the first liquid crystal capacitor Clca and the output terminal of the third switching element Qc, and the output terminal of the second switching element Qb is connected to the second liquid crystal capacitor Clcb.

The third switching element Qc is also a three-terminal element such as a thin film transistor of which a control terminal is connected to the gate line Gi, an input terminal is connected to the second voltage transmitting part T2 connected to the second reference voltage line C2, and an output terminal is connected to the first liquid crystal capacitor Clca.

The fifth pixel PX5 includes the gate line Gi, the fifth data line D(j+4), the first voltage transmitting part T1 connected to the first reference voltage line C1, and the first switching element Qa, the second switching element Qb, the third switching element Qc, the first liquid crystal capacitor Clca, and the second liquid crystal capacitor Clcb.

The first switching element Qa and the second switching element Qb are connected to the gate line Gi and the fifth data line D(j+4). The third switching element Qc is connected to the gate line Gi, the first voltage transmitting part T1 connected to the first reference voltage line C1, and the output terminal connected to the first switching element Qa.

The first switching element Qa and the second switching element Qb are three-terminal elements such as a thin film transistor of which a control terminal is connected to the gate line Gi and an input terminal is connected to the fifth data line D(j+4). The output terminal of the first switching element Qa is connected to the first liquid crystal capacitor Clca and the output terminal of the third switching element Qc, and the output terminal of the second switching element Qb is connected to the second liquid crystal capacitor Clcb.

The third switching element Qc is a three-terminal element such as a thin film transistor of which a control terminal is connected to the gate line Gi, an input terminal is connected to the first voltage transmitting part T1 connected to the first reference voltage line C1, and an output terminal is connected to the first liquid crystal capacitor Clca.

The sixth pixel PX6 includes the gate line Gi, the sixth data line D(j+5), the second reference voltage line C2, and the first switching element Qa, the second switching element Qb, the third switching element Qc, the first liquid crystal capacitor Clca, and the second liquid crystal capacitor Clcb.

The first switching element Qa and the second switching element Qb are connected to the gate line Gi and the sixth data line D(j+5), and the third switching element Qc is connected to the gate line Gi, the second reference voltage line C2, and the output terminal of the first switching element Qa.

The first switching element Qa and the second switching element Qb are three-terminal elements such as a thin film transistor of which a control terminal is connected to the gate line Gi and an input terminal is connected to the sixth data line D(j+5). The output terminal of the first switching element Qa is connected to the first liquid crystal capacitor Clca and the output terminal of the third switching element Qc, and the output terminal of the second switching element Qb is connected to the second liquid crystal capacitor Clcb.

The third switching element Qc is a three-terminal element such as a thin film transistor of which a control terminal is connected to the gate line Gi, an input terminal is connected to the second reference voltage line C2, and an output terminal is connected to the first liquid crystal capacitor Clca.

The first reference voltage line C1 and the second reference voltage line C2 extend parallel to the data lines Dj, D(j+1), D(j+2), D(j+3), D(j+4), and D(j+5), and are alternately placed every three data lines. For example, the first reference voltage line C1 is placed to the right of the three data lines Dj, D(j+1) and D(j+2), and the second reference voltage line C2 is placed to the right of the next three data lines D(j+3), D(j+4) and D(j+5).

The first voltage transmitting part T1 connected to the first reference voltage line C1 and the second voltage transmitting part T2 connected to the second reference voltage line C2 are alternately disposed in the six pixels PX1, PX2, PX3, PX4, PX5, and PX6.

If a gate-on signal is applied to the gate line Gi, the first switching element Qa, the second switching element Qb, and the third switching element Qc of six pixels PX1, PX2, PX3, PX4, PX5, and PX6 connected thereto are turned on. Accordingly, the data voltage applied to the first data line Dj is applied to one terminal of the first liquid crystal capacitor Clca and second liquid crystal capacitor Clcb of the first pixel PX1 through the turned-on first switching element Qa and second switching element Qb of the first pixel PX1. Similarly, the data voltage applied to the second data line D(j+1) is applied to one terminal of the first liquid crystal capacitor Clca and second liquid crystal capacitor Clcb of the second pixel PX2 through the turned-on first switching element Qa and second switching element Qb of the second pixel PX2. The data voltage applied to the third data line D(j+2) is applied to one terminal of the first liquid crystal capacitor Clca and second liquid crystal capacitor Clcb of the third pixel PX3 through the turned-on first switching element Qa and second switching element Qb of the third pixel PX3. The data voltage applied to the fourth data line D(j+3) is applied to one terminal of the first liquid crystal capacitor Clca and second liquid crystal capacitor Clcb of the fourth pixel PX4 through the turned-on first switching element Qa and second switching element Qb of the fourth pixel PX4. The data voltage applied to the fifth data line D(j+4) is applied to one terminal of the first liquid crystal capacitor Clca and second liquid crystal capacitor Clcb of the fifth pixel PX5 through the turned-on first switching element Qa and second switching element Qb of the fifth pixel PX5. The data voltage applied to the sixth data line D(j+5) is applied to one terminal of the first liquid crystal capacitor Clca and second liquid crystal capacitor Clcb of the sixth pixel PX6 through the turned-on first switching element Qa and second switching element Qb of the sixth pixel PX6.

At this time, the first liquid crystal capacitor Clca and the second liquid crystal capacitor Clcb of the first pixel PX1 are charged to a potential difference between the data voltage applied to the first data line Dj and the common voltage applied to a common electrode 270. Similarly, the first liquid crystal capacitor Clca and the second liquid crystal capacitor Clcb of the second pixel PX2 are charged to a potential difference between the data voltage applied to the second data line D(j+1) and the common voltage applied to the common electrode 270. The first liquid crystal capacitor Clca and the second liquid crystal capacitor Clcb of the third pixel PX3 are charged to a potential difference between the data voltage applied to the third data line D(j+2) and the common voltage applied to the common electrode 270. The first liquid crystal capacitor Clca and the second liquid crystal capacitor Clcb of the fourth pixel PX4 are charged to a potential difference between the data voltage applied to the fourth data line D(j+3) and the common voltage applied to the common electrode 270. The first liquid crystal capacitor Clca and the second liquid crystal capacitor Clcb of the fifth pixel PX5 are charged to a potential difference between the data voltage applied to the fifth data line D(j+4) and the common voltage applied to the common electrode 270. The first liquid crystal capacitor Clca and the second liquid crystal capacitor Clcb of the sixth pixel PX6 are charged to a potential difference of the data voltage applied to the sixth data line D(j+5) and the common voltage applied to the common electrode 270.

Simultaneously, the first liquid crystal capacitors Clca of the first, the third and the fifth pixels PX1, PX3, and PX5 are connected to the output terminals of the third switching elements Qc of the first, the third and the fifth pixels PX1, PX3 and PX5. For example, the reference voltage which is applied to the first reference voltage line C1 is applied through the third switching elements Qc of the first, the third and the fifth pixels PX1, PX3 and PX5 to the first liquid crystal capacitors Clca of the first, the third and the fifth pixels PX1, PX3 and PX5. If the first reference voltage applied to the first reference voltage line C1 has the same polarity as the data voltages applied to the first data line Dj, the third data line D(j+2), and the fifth data line D(j+4), and has a larger magnitude than the data voltages applied to the first data line Dj, the third data line D(j+2), and the fifth data line D(j+4), the voltage charged to the first liquid crystal capacitor Clca is higher (or boosted to a higher voltage level) than the data voltage applied to the first data line Dj, the third data line D(j+2), and the fifth data line D(j+4). For example, the first reference voltage applied to the first reference voltage line C1 is applied through the third switching elements Qc of the first, the third and the fifth pixels PX1, PX3 and PX5 to the first liquid crystal capacitors Clca of the first, the third and the fifth pixels PX1, PX3 and PX5.

Also, the first liquid crystal capacitors Clca of the second, the fourth and the sixth pixels PX2, PX4, and PX6 are connected to the output terminals of the third switching elements Qc of the second, the fourth and the sixth pixels PX2, PX4 and PX6. For example, the reference voltage which is applied to the second reference voltage line C2 is applied through the third switching elements Qc of the second, the fourth and the sixth pixels PX2, PX4 and PX6. If the second reference voltage applied to the second reference voltage line C2 has the same polarity as the data voltage applied to the second data line D(j+1), the fourth data line D(j+3), and the sixth data line D(j+5), and has a larger magnitude than the data voltage applied to the second data line D(j+1), the fourth data line D(j+3), and the sixth data line D(j+5), the voltage charged to the first liquid crystal capacitors Clca of the second, the fourth and the sixth pixels PX2, PX4 and PX6 is higher (or boosted to a higher voltage level) than the data voltage applied to the second data line D(j+1), the fourth data line D(j+3), and the sixth data line D(j+5). For example, the second reference voltage applied to the second reference voltage line C2 is applied through the third switching elements Qc of the second, the fourth and the sixth pixels PX2, PX4 and PX6 to the first liquid crystal capacitors Clca of the second, the fourth and the sixth pixels PX2, PX4 and PX6.

Accordingly, the voltage charged in the first liquid crystal capacitor Clca and the voltage charged in the second liquid crystal capacitor Clcb are different from each other. Since the voltage charged in the first liquid crystal capacitor Clca and the voltage charged in the second liquid crystal capacitor Clcb are different from each other or independently controlled from each other, inclined angles of liquid crystal molecules are different from each other or independently controlled from each other in the first subpixel and the second subpixel, and thus luminances of the two subpixels are different from each other or independently controlled from each other. Accordingly, the voltage charged in the first liquid crystal capacitor Clca and the voltage charged in the second liquid crystal capacitor Clcb are controlled such that an image viewed from the side may be substantially similar to an image viewed from the front, thereby improving side visibility.

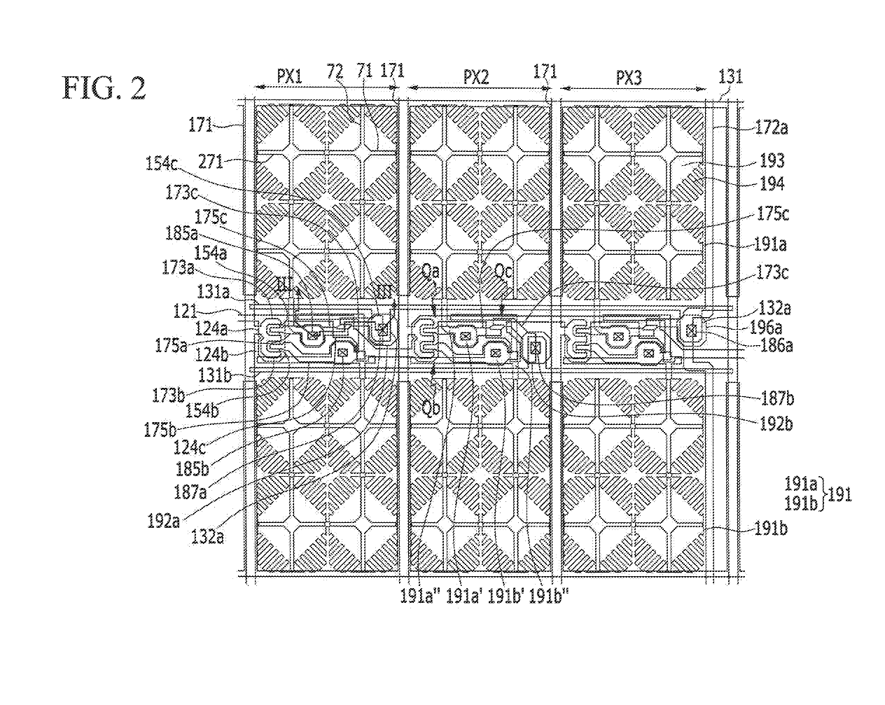

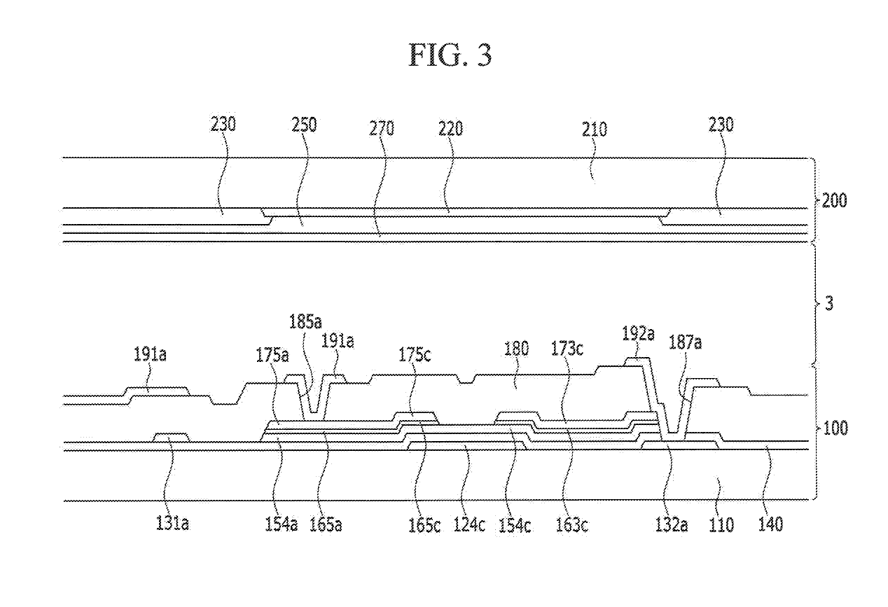

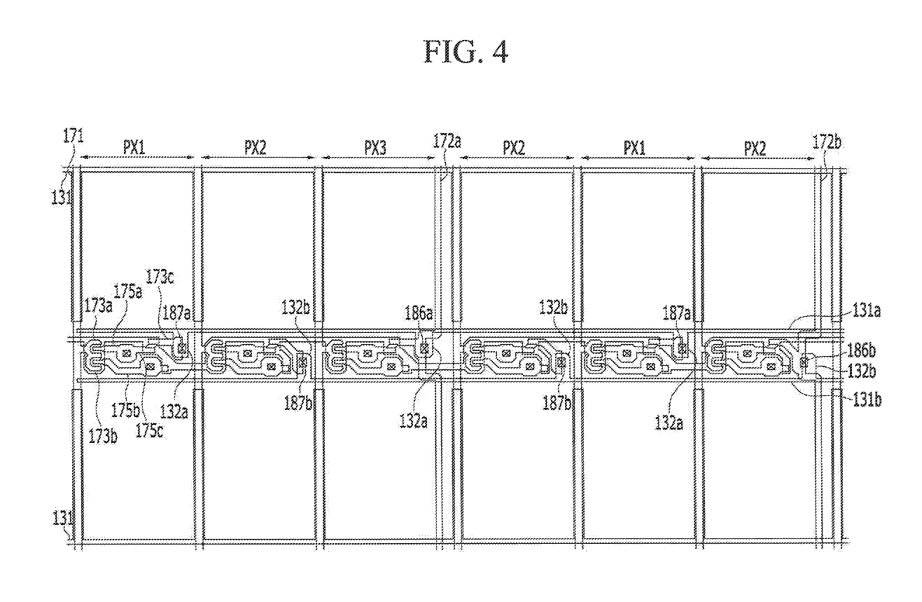

Next, a liquid crystal display according to an exemplary embodiment of the present invention will be described with reference to FIG. 2 to FIG. 4. FIG. 2 is a layout view of the liquid crystal display according to an exemplary embodiment of the present invention. FIG. 3 is a cross-sectional view of the liquid crystal display of FIG. 2 taken along line FIG. 4 is a layout view of a portion of the liquid crystal display of FIG. 2.

Referring to FIG. 2 to FIG. 4, the liquid crystal display includes a lower panel 100 and an upper panel 200 which face each other, and a liquid crystal layer 3 injected between the two panels 100 and 200.

First, the lower panel 100 will be described.

A gate conductor including a gate line 121 (Gi of FIG. 1), a storage electrode line 131, a first voltage transmitting part 131a (T1 of FIG. 1), and a second voltage transmitting part 131b (T2 of FIG. 1) is formed on a first substrate 110.

The gate line 121 transfers a gate signal, and includes a first gate electrode 124a (for Qa of FIG. 1), a second gate electrode 124b (Qb of FIG. 1) and a third gate electrode 124c (for Qc of FIG. 1).

The first voltage transmitting part 131a and the second voltage transmitting part 131b are connected to a first reference voltage line 172a (C1 of FIG. 1) and the second reference voltage line 172b (C2 of FIG. 2) that will be described later.

The first voltage transmitting part 131a includes a first extension 132a (T1), and the second voltage transmitting part 131b includes a second extension 132b (T2).

A gate insulating layer 140 is positioned on the gate conductors 121, 131, 131a, and 131b.

A first semiconductor 154a and a third semiconductor 154c are disposed on the gate insulating layer 140. Similarly, a second semiconductor 154b may be disposed on the gate insulating layer 140.

Ohmic contacts 165a and 165c are disposed on the first semiconductor 154a, and the third semiconductor 154c. Similarly, an ohmic contact 163c may be disposed on the second semiconductor 154b. The semiconductors 154a, 154b, and 154c may include an oxide semiconductor, and in this case, the ohmic contacts may be omitted.

A data conductor including a data line 171, a third source electrode 173c, a first drain electrode 175a, a second drain electrode 175b, a third drain electrode 175c, the first reference voltage line 172a, and the second reference voltage line 172b is formed on the ohmic contacts 165a, 163c, and 165c and the gate insulating layer 140. The data line 171 includes a first source electrode 173a and a second source electrode 173b. The first drain electrode 175a and the third drain electrode 175c are connected to each other.

The first reference voltage line 172a and the second reference voltage line 172b extend parallel to the data line 171, are disposed for three pixels, and are alternately positioned.

A passivation layer 180 is positioned on the data conductors 173c, 175a and 175c, as shown in FIG. 3. Similarly, the passivation layer 180 may be positioned on the data conductors 171, 172a, 172b, 173a and 175b. The passivation layer 180 may include an inorganic insulator or an organic insulator.

The passivation layer 180 has a first contact hole 185a exposing a portion of the first drain electrode 175a and a second contact hole 185b exposing a portion of the second drain electrode 175b.

The gate insulating layer 140 and the passivation layer 180 have a third contact hole 186a through which the first reference voltage line 172a, the first extension 132a of the first voltage transmitting part 131a, and the third source electrode 173c are connected to each other. The gate insulating layer 140 and the passivation layer 180 have a fourth contact hole 186b through which the second reference voltage line 172b, the second extension 132b of the second voltage transmitting part 131b, and the third source electrode 173c are connected to each other.

The gate insulating layer 140 and the passivation layer 180 have a fifth contact hole 187a through which the first extension 132a of the first voltage transmitting part 131a and the third source electrode 173c are connected to each other. The gate insulating layer 140 and the passivation layer 180 have a sixth contact hole 187b through which the second extension 132b of the second voltage transmitting part 131b and the third source electrode 173c are connected to each other.

A pixel electrode including a first subpixel electrode 191a and a second subpixel electrode 191b, a first connecting member 192a, a second connecting member 192b, and a third connecting member 196a are formed on the passivation layer 180.

The first subpixel electrode 191a is physically and electrically connected to the first drain electrode 175a through the first contact hole 185a, and the second subpixel electrode 191b is physically and electrically connected to the second drain electrode 175b through the second contact hole 185b.

The first subpixel electrode 191a and the second subpixel electrode 191b are separated from each other with the gate line 121 therebetween, and are disposed in the upper and the lower sides of a pixel area along a column direction crossing a direction along which the gate line 121 is extended. The first subpixel electrode 191a and the second subpixel electrode 191b include a plate-shaped portion 193 having a rhombus shape and branch electrodes 194 extending in four directions from the plate shape portion 193. The branch electrodes 194 include a portion obliquely extending in a right-upper direction, a portion obliquely extending in a right-lower direction, a portion obliquely extending in a left-upper direction, and a portion obliquely extending in a left-lower direction. The first subpixel electrode 191a is connected to the first drain electrode 175a (which corresponds to the outputs of Qa and Qc) through a first subpixel electrode pad 191a′ and a first subpixel electrode connection 191a″. The first subpixel electrode pad 191a′ is connected to the first drain electrode 175a through the first contact hole 185a. The second subpixel electrode 191b is connected to the second drain electrode 175b (which corresponds to the output of Qb) through a second subpixel electrode pad 191b′ and a second subpixel electrode connection 191b″. As described above, inclined directions of the liquid crystal molecules in each portion where the plurality of branch electrodes 194 extend in the different directions are different from each other. Accordingly, four domains where the inclination directions of the liquid crystal molecules are different are formed in the liquid crystal layer 3. As described above, when the inclined directions of the liquid crystal molecules are varied, a reference viewing angle of the liquid crystal display increases.

The first subpixel electrode 191a and the second subpixel electrode 191b are divided into sub-regions by the plate shape portion 193 having the rhombus shape and the branch electrodes 194 extending from the plate shape portion 193 in four directions.

An area of the second subpixel electrode 191b may be larger than an area of the first subpixel electrode 191a.

However, the shape of the first subpixel electrode 191a and the second subpixel electrode 191b of the liquid crystal display according to an exemplary embodiment of the present invention is not limited thereto, and thus, the first subpixel electrode 191a and the second subpixel electrode 191b may have various shapes.

The first connecting member 192a and the second connecting member 192b are formed on the fifth contact hole 187a and the sixth contact hole 187b. The first connecting member 192a connects the first reference voltage line 172a, the first extension 132a of the first voltage transmitting part 131a, and the third source electrode 173c of the first pixel PX1 to each other. The second connecting member 192b connects the second reference voltage line 172b, the second extension 132b of the second voltage transmitting part 131b, and the third source electrode 173c of the second pixel PX2 to each other.

The third connecting member 196a is formed on the third contact hole 186a to connect the first extension 132a of the first voltage transmitting part 131a and the third source electrode 173c of the third pixel PX3 to each other.

The first gate electrode 124a, the first semiconductor 154a, the first source electrode 173a, and the first drain electrode 175a form a first switching element Qa. The second gate electrode 124b, the second semiconductor 154b, the second source electrode 173b, and the second drain electrode 175b form a second switching element Qb. The third gate electrode 124c, the third semiconductor 154c, the third source electrode 173c, and the third drain electrode 175c form a third switching element Qc.

Now, the upper panel 200 will be described.

A light blocking member 220 is positioned on a second insulation substrate 210. The light blocking member 220 may be referred to as a black matrix, serving to block light leakage. Color filters 230 are disposed on the second insulation substrate 210 and the light blocking member 220. An overcoat layer 250 is disposed on the color filters 230. The overcoat layer 250 serve to prevent the color filters 230 and the light blocking member 220 from being detached, and suppress contamination of the liquid crystal layer 3 due to an organic material such as a solvent which is inputted from the color filter 230 to thereby prevent a defect such as an afterimage which may be caused during screen driving, and the overcoat layer 250 may be omitted. A common electrode 270 is disposed on the overcoat layer 250. The common voltage is applied to the common electrode 270.

The light blocking member 220 and the color filters 230 are disposed on the upper panel 200. Alternatively, the light blocking member 220 and the color filters 230 of the liquid crystal display may be disposed on the lower panel 100. In this case, the color filters 230 may be disposed on the passivation layer 180 of the lower panel 100.

The common electrode 270, when viewed from the above as shown in FIG. 2, has a cross-shaped cutout 271 formed at the position corresponding to each sub-region of the first subpixel electrode 191a and the second subpixel electrode 191b. The cross-shaped cutout 271 of the common electrode 270 includes a transverse cutout 71 parallel to the gate line 121 and a longitudinal stem 72 parallel to the data line 171.

When viewed from the above of the liquid crystal display, each sub-region of the first subpixel electrode 191a and the second subpixel electrode 191b is divided into four regions by the cross-shaped cutout 271 of the common electrode 270 and the branch electrodes 194 of the subpixel electrodes 191a and 191b.

The first subpixel electrode 191a, the common electrode 270 and the liquid crystal layer 3 disposed therebetween form the first liquid crystal capacitor Clca. The second subpixel electrode 191b, the common electrode 270 and the liquid crystal layer 3 disposed therebetween form the second liquid crystal capacitor Clcb.

An electric field is applied to the liquid crystal layer 3 by potential differences between voltages which are applied to the first subpixel electrode 191a and second subpixel electrode 191b and the common voltage which is applied to the common electrode 270. The orientations of the liquid crystal molecules of the liquid crystal layer 3 are determined according to the intensity of the electric field. As described above, luminance of light which passes through the liquid crystal layer 3 varies according to the orientations of the liquid crystal molecules.

Referring to FIG. 4, as described above, the first reference voltage line 172a and the second reference voltage line 172b extend parallel to the data line 171 and are alternately disposed one by one for three data lines 171.

The first voltage transmitting part 131a is connected to the first reference voltage line 172a. The second voltage transmitting part 131b is connected to the second reference voltage line 172b. The first extensions 132a are protruded toward the contact holes 187a and 186a. The second extensions 132b are protruded toward the contact holes 187b and 186b. The first and the second extension are alternately disposed in the six pixels PX1, PX2, PX3, PX4, PX5, and PX6.

Among the six pixels PX1, PX2, PX3, PX4, PX5, and PX6 sequentially positioned, the first pixel PX1, the third pixel PX3, and the fifth pixel PX5 are connected to the first voltage transmitting part 131a connected to the first reference voltage line 172a, and the second pixel PX2, the fourth pixel PX4, and the sixth pixel PX6 are connected to the second voltage transmitting part 131b connected to the second reference voltage line 172b.

The first reference voltage line 172a and the second reference voltage line 172b are applied with the first reference voltage and the second reference voltage of a predetermined magnitude, and polarities of the first reference voltage and the second reference voltage are changed for each frame. For example, if the magnitude of the common voltage is about 7.5 V, the first reference voltage may have a value of about 15 V or about 0 V for each frame, and the second reference voltage may have a value of about 0 V or about 15 V. For example, when the first reference voltage is about 15V (or about 0V), the second reference voltage is about 0V (or about 15V). The first reference voltage and the second reference voltage may be larger or smaller than a maximum value of the data voltage. Further, first voltage differences are created between the first and second reference voltages and the common voltage if the reference voltages have positive polarities with respect to the common voltage. Second voltage differences are created between the first and second reference voltages and the common voltage if the first reference voltage and the second reference voltage have negative polarities with respect to the common voltage. The first voltage differences may be different from the second voltage differences.

The first reference voltage line 172a and the second reference voltage line 172b extend parallel to the data line 171, and the first and second reference voltage lines 172a and 172b do not overlap the subpixel electrodes 191a and 191b. Accordingly, changes in the polarities of the first reference voltage and the second reference voltage between successive frames does not affect the pixel voltage applied to the first and second subpixel electrodes 191a and 191b. This will be described with reference to FIG. 5. FIG. 5 is a waveform diagram for describing a voltage change of a pixel area according to voltage which is applied for each frame.

Referring to FIG. 5, a first reference voltage Vc1 applied to the first reference voltage line 172a has a value of about 15 V for a first frame, about 0 V for a second frame, and about 15 V for a third frame. A second reference voltage Vc2 applied to the second reference voltage line 172b has a value of about 0 V for a first frame, about 15 V for a second frame, and about 0 V for a third frame.

As described above, although polarities of the first reference voltage Vc1 and the second reference voltage Vc2 having different polarities are changed in successive frames, since the subpixel electrodes 191a and 191b are not overlapped with the first reference voltage line 172a and the second reference voltage line 172b, changes in storage capacitance of the storage capacitors according to the polarity change of the first reference voltage Vc1 and the second reference voltage Vc2 are cancelled. Accordingly, the magnitude of a voltage Vp which is charged in each of the subpixel electrodes 191a and 191b is kept as constant.

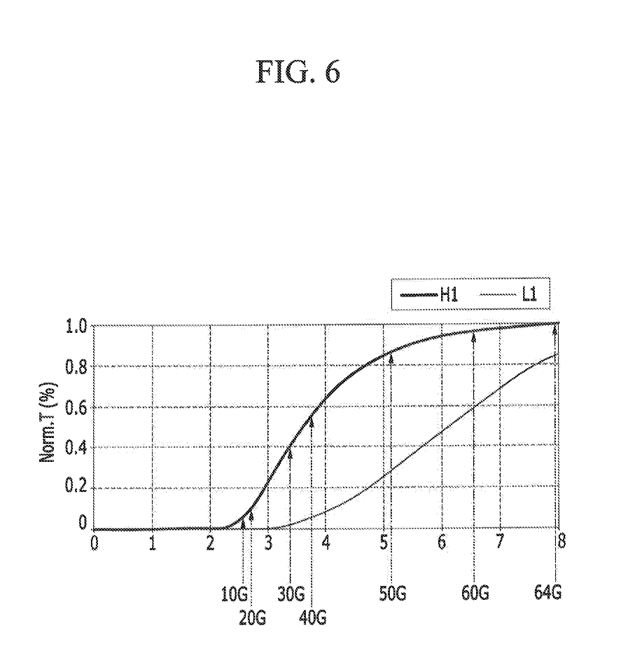

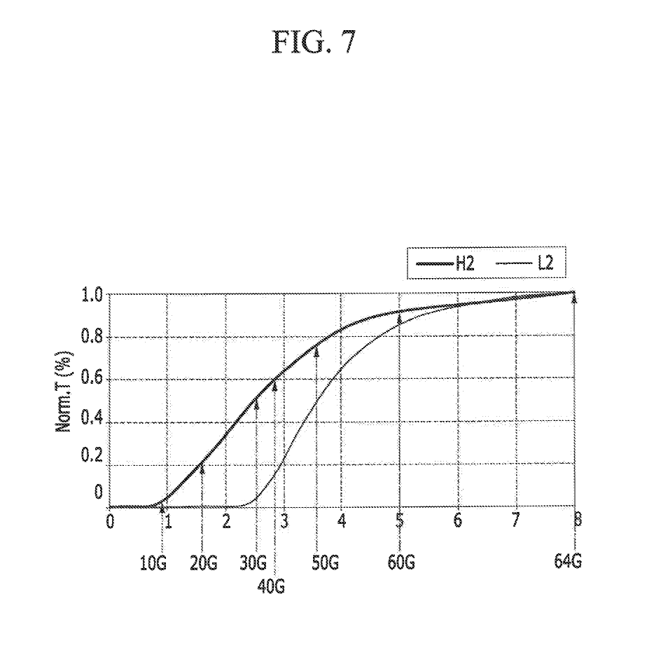

Next, a transmittance change depending on a pixel voltage of a liquid crystal display according to an exemplary embodiment of the present invention will be described with reference to FIG. 6 and FIG. 7. FIG. 6 and FIG. 7 are graphs illustrating a transmittance change according to the pixel voltage of a liquid crystal display. In this example, a gradational display (change in transmittance between the transparent and opaque states) is performed between the voltage of about 0 V and the voltage of 8 V.

Referring to FIG. 6, a transmittance change is shown for a comparative example of a liquid crystal display having a pixel electrode including a first subpixel electrode and a second subpixel electrode. In the comparative liquid crystal display, a data voltage applied to the second subpixel electrode may be divided between the first subpixel electrode and the second subpixel electrode, and thus a voltage supplied to the second subpixel electrode may become lower than the applied data voltage. In this case, a transmittance change H1 is for the first subpixel electrode and a transmittance change L1 is for the second subpixel electrode.

For example, the divided voltage of the second subpixel electrode is lowered by a predetermined value. Accordingly, if the data voltage is relatively small, for example, about 4 V or less, the transmittance change of the pixel is determined mostly by the transmittance H1 of the first subpixel electrode. This region corresponds to part of a low gray region of about a 20 gray 20G, and as a result, the gray expression is discernible in the low gray region. Between about 4V and about 6.7V which correspond to between about the 20 gray 20G and about a 40 gray 40G, the rate of the transmittance change increases such that the transmittance change of the pixel makes a screen shown as white. In this way, it is difficult to express the gray depending on the data voltage in the low gray region. In the case of a high gray region where the data voltage is about 6.7 V or more for example, the transmittance change of the pixel which is mostly determined by the voltage of the second subpixel electrode is decreased and thus the transmittance of the liquid crystal display becomes lower than the data voltage. Accordingly, transmittance efficiency of the liquid crystal display is lowered as the data voltage increases.

Referring to FIG. 7, a transmittance change is shown for an exemplary liquid crystal display according to the present invention. A pixel electrode includes a first subpixel electrode and a second subpixel electrode. A data voltage is supplied to the pixel, and a voltage applied to the first subpixel electrode is controlled to become higher than the data voltage, as described above with reference to FIGS. 1 to 5. A transmittance change H2 is for the first subpixel electrode, and a transmittance change L2 is for the second subpixel electrode.

For example, the voltage of the first subpixel electrode of the first subpixel electrode and the second subpixel electrode corresponds to a data voltage supplied through a data line, and the voltage of the second subpixel electrode is controlled to increase by a predetermined value, In this case, the transmittance change is large enough to make gray expressions discernible in the low gray where the data voltage is below about 6.7V. The rate of increase in the transmittance change according to the data voltage is substantially constant in the low gray region and thus the transmittance is rapidly increased in a predetermined gray, and as a result, a phenomenon in which a screen is shown as white may be prevented. Further, in the case of a high gray region where the data voltage is about 6.7 V or more for example, decrease in the transmittance change is small such that the entire transmittance of the liquid crystal display is increased. Accordingly, driving efficiency of the liquid crystal display is increased.

According to an exemplary embodiment of the present invention, while side visibility is close to front visibility, an accurate gray may be expressed in a low gray region, the luminance may be prevented from being decreased as compared with applied the driving voltage, and the magnitude of the pixel voltage may be prevented from being changed by the first reference voltage line and the second reference voltage line supplying the first voltage and the second voltage of the different polarities.

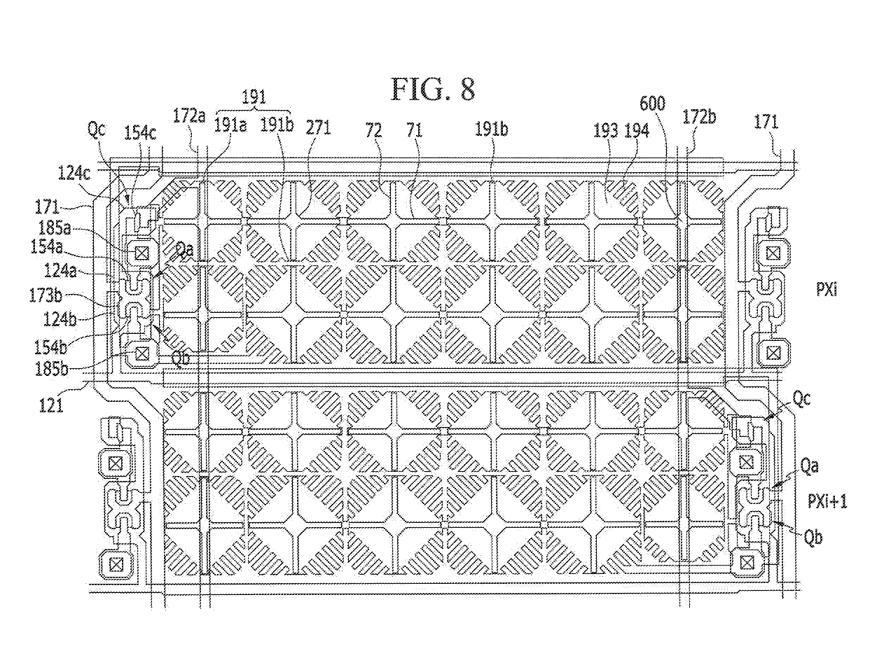

Next, a liquid crystal display according to an exemplary embodiment of the present invention will be described with reference to FIG. 8. FIG. 8 is a layout view of a liquid crystal display according to an exemplary embodiment of the present invention.

Referring to FIG. 8, the liquid crystal display according to the present exemplary embodiment, like the liquid crystal display according to the exemplary embodiment described with reference to FIG. 1 to FIG. 4, includes the first switching element Qa connected to the first subpixel electrode 191a, the second switching element Qb connected to the second subpixel electrode 191b, and the third switching element Qc connected to the second subpixel electrode 191b and the first reference voltage line 172a or second reference voltage line 172b. A pixel electrode 191 includes the first and the second subpixel electrodes 191a and 191b.

However, unlike the liquid crystal display of FIG. 1 to FIG. 4, the pixel electrode 191 is longer in the extending direction of the gate line 121 than in the extending direction of the data line 171. As described above, if the pixel electrode 191 is elongated in the horizontal direction, the number of the data lines 171 may be reduced, thereby reducing a cost of the driver.

The switching elements Qa, Qb and Qc are not arranged between the first subpixel electrode 191a and the second subpixel electrode 191b. For example, the switching elements Qa, Qb and Qc are placed in one side of the pixel electrode 191. The first reference voltage line 172a and the second reference voltage line 172b extend parallel to the data line 171 and are positioned between two adjacent data lines 171.

Two adjacent pixels PXi and PX(i+1) adjacent in the pixel column direction are connected to the first reference voltage line 172a or the second reference voltage line 172b, and each pixel is alternately connected to the first reference voltage line 172a and the second reference voltage line 172b with reference to one pixel column.

Also, unlike the liquid crystal display of FIG. 1 to FIG. 4, the pixel electrode 191 of each pixel overlaps both the first reference voltage line 172a and the second reference voltage line 172b. For example, the reference voltage lines 172a and 172b overlap a center region 600 of a cross-shaped cutout 271 in a common electrode.

As described above, since the pixel electrode 191 of each pixel overlaps the first reference voltage line 172a and the second reference voltage line 172b applied with the first reference voltage and the second reference voltage of the different polarities, the pixel voltage of the pixel electrode 191 is not affected, although the polarity of the first reference voltage and the second reference voltage is changed in successive frames.

While the present invention has been shown and described with reference to exemplary embodiments thereof, it will be apparent to those of ordinary skill in the art that various changes in form and detail may be made therein without departing from the spirit and scope of the present invention as defined by the following claims.

What is claimed is:

1. A liquid crystal display comprising:
a first reference voltage line supplied with a first reference voltage;
a second reference voltage line supplied with a second reference voltage;
a first data line;
a second data line;
a first pixel including a first switching element, a second switching element, a third switching element, a first subpixel electrode, a second subpixel electrode and a common electrode, wherein the first switching element is configured to electrically connect the first data line to the first subpixel electrode, wherein the second switching element is configured to electrically connect the first data line to the second subpixel electrode, wherein the third switching element is configured to electrically connect the first reference voltage line to the first subpixel electrode; and
a second pixel including a fourth switching element, a fifth switching element, a sixth switching element, a third subpixel electrode, a fourth subpixel electrode and the common electrode, wherein the fourth switching element is configured to electrically connect the second data line to the third subpixel electrode, wherein the fifth switching element is configured to electrically connect the second data line to the fourth subpixel electrode, wherein the sixth switching element is configured to electrically connect the second reference voltage line to the third subpixel electrode,
wherein a polarity of the first reference voltage is different from a polarity of the second reference voltage with respect to a common voltage supplied to the common electrode,
wherein liquid crystal molecules are disposed between the first subpixel electrode and the common electrode and between the second subpixel electrode and the common electrode.

2. The liquid crystal display of claim 1, further comprising a gate line which is commonly connected to the first switching element, the second switching element, the third switching element, the fourth switching element, the fifth switching element, and the sixth switching element.

3. The liquid crystal display of claim 1, wherein the first switching element, the second switching element and the third switching element are disposed between the first subpixel electrode and the second subpixel electrode.

4. The liquid crystal display of claim 1, wherein the first subpixel electrode is adjacent to the second subpixel electrode along a first direction where the first reference voltage line is extended, and wherein the first switching element, the second switching element and the third switching element are adjacent to the first and the second subpixel electrodes along a second direction crossing the first direction, wherein the first switching element, the second switching element and the third switching element are not disposed between the first subpixel electrode and the second subpixel electrode.

5. The liquid crystal display of claim 1, further comprising a third pixel, a fourth pixel, a fifth pixel, a sixth pixel, wherein the first pixel, the second pixel and the third pixel are disposed to the left of the first reference voltage line, wherein the fourth pixel, the fifth pixel and the sixth pixel are disposed to the right of the first reference voltage line and to the left of the second reference voltage line.

6. The liquid crystal display of claim 5, wherein the first reference voltage line and the second reference voltage line parallel to each other are extended in a first direction, wherein the first to the sixth pixels are arranged in a second direction crossing the first direction.

7. The liquid crystal display of claim 1, wherein the first subpixel electrode does not overlap the first and the second reference voltage lines, and wherein the second subpixel electrode does not overlap the first and the second reference voltage lines.

8. The liquid crystal display of claim 1, wherein each of the first subpixel electrode and the second subpixel electrode includes a plate portion and a plurality of branch electrodes extending from the plate portion, and wherein the common electrode includes a crossed-shape cutout overlapping the plate portion.

9. The liquid crystal display of claim 1, wherein a data voltage applied to the first data line has the same polarity with respect to the common voltage as at least one of the first and the second reference voltages.

10. The liquid crystal display of claim 9, wherein a magnitude of the at least one of the first and the second reference voltages is greater than a magnitude of the data voltage.

11. The liquid crystal display of claim 1, wherein the polarity of the first reference voltage is changed in continuous frames.

12. The liquid crystal display of claim 1, wherein an inclination direction of the liquid crystal molecules disposed between the first subpixel electrode and the common electrode is controlled by a first voltage difference between the common voltage and the first reference voltage, and wherein an inclination direction of the liquid crystal molecules disposed between the second subpixel electrode and the common electrode is controlled by a second voltage difference between a data voltage supplied to the first data line and the common voltage, wherein the first voltage difference is greater than the second voltage difference.

13. A liquid crystal display comprising:
a gate line;
a data line;
a first reference voltage line and a second reference voltage line supplied with a first reference voltage and a second reference voltage having different polarities from each other;
a pixel, electrode including a first subpixel electrode and a second subpixel electrode;
a common electrode supplied with a common voltage;
a first switching element connected to the gate line, the data line, and the first subpixel electrode;
a second switching element connected to the gate line, the data line, and the second subpixel electrode; and
a third switching element connected to the gate line, the first subpixel electrode, and one of the first reference voltage line and, the second reference voltage line,
wherein the pixel electrode overlaps the first reference voltage line and the second reference voltage line, and wherein a voltage difference between the first subpixel electrode and the common electrode is greater than a voltage difference between the second subpixel electrode and the common electrode.

14. The liquid crystal display of claim 13, wherein each of the first subpixel electrode and the second subpixel electrode includes a plate portion and a plurality of branch electrodes extending from the plate portion,
wherein the common electrode includes a crossed-shape cutout overlapping the plate portion.

15. The liquid crystal display of claim 14, wherein a data voltage applied to the data line has the same polarity with respect to the common voltage as at least one of the first and the second reference voltages.

16. The liquid crystal display of claim 15, wherein
a magnitude of the at least one of the first and the second reference voltages is greater than a magnitude of the data voltage.

17. The liquid crystal display of claim 13, wherein the polarity of the first reference voltage is changed in continuous frames, and the polarity of the second reference voltage is different from the polarity of the first reference voltage.

18. The liquid crystal display of claim 14, wherein the first reference voltage line and the second reference voltage line overlap a center region of the crossed-shaped cutout of the common electrode.

19. The liquid crystal display of claim 13, wherein a first side of the pixel electrode is longer than a second side of the pixel electrode, wherein the first side is extended in an extending direction of the gate line and the second side is extended in an extending direction of the data line.

20. The liquid crystal display of claim 19, wherein the first switching element, the second switching element and the third switching element are adjacent to the second side of the pixel electrode.
